(19) United States
(12) Patent Application Publication
(10) Pub. No.: US 2011/0069345 A1
(43) Pub. Date: Mar. 24, 2011

(54) IMAGE FORMING APPARATUS FOR PACKET CAPTURE SYSTEM, AND CONTROL METHOD AND STORAGE MEDIUM THEREFOR

(75) Inventor: Kaori Ishibashi, Omihachiman-shi (JP)

(73) Assignee: CANON KABUSHIKI KAISHA, Tokyo (JP)

(21) Appl. No.: 12/877,865

(22) Filed: Sep. 8, 2010

(30) Foreign Application Priority Data
Sep. 18, 2009 (JP) 2009-217432

(51) Int. Cl. G06F 3/12

(52) U.S. Cl. 358/1.15

(57) ABSTRACT

An image forming apparatus that enables a plurality of image forming apparatuses to acquire packet data according to an operation of the image forming apparatus. A packet acquisition control unit of a first image forming apparatus gives a packet acquisition unit of the first image forming apparatus a packet acquisition start instruction and a packet acquisition completion instruction and transmits a packet data acquisition start request and a packet data acquisition completion request to a second image forming apparatus. Packet data acquired by the packet acquisition unit of the first image forming apparatus and packet data acquired by the second image forming apparatus are stored so as to be associated with each other.

### BACKGROUND OF THE INVENTION

1. Field of the Invention

The present invention relates to an image forming apparatus of a packet capture system for acquiring packets flowing through a network, and a control method and a storage medium for the image forming apparatus.

2. Description of the Related Art

In recent years, various apparatuses such as information processing apparatuses (e.g., personal computers (PCs)) and image forming apparatuses (e.g., copying machines and printers) are connected to an enterprise network. The number of apparatuses connected to a network has continued increasing, and different networks become connected to one another. Therefore, the scale of networks becomes larger. As a result, once a network failure occurs, there is a fear that a large number of network-connected apparatuses are affected so that business operations are disturbed.

The causes of network failure are multiple, such as an erroneous setting of a network-connected apparatus and excess traffic. It is therefore necessary to promptly locate the cause of a network failure that has occurred and take an appropriate countermeasure. As effective means for locating the cause of network failure, it has generally been known to acquire network packets and analyze the contents of the packets.

Heretofore, in order to acquire network packets, a dedicated PC must be connected to a network considered to have trouble and packet acquisition software must be executed on the PC. In recent years, however, some network-connected apparatuses (e.g., image forming apparatuses) have a packet acquisition function and are able to acquire and hold communication packets.

For example, Japanese Laid-open Patent Publication No. 2001-274806 discloses a technique of using a packet acquisition function of an image forming apparatus to acquire and analyze packets flowing through a network during a given time period and using an analysis result to make a network setting for the image forming apparatus.

As described above, it is known in image forming apparatuses to acquire packets flowing through a network for a given time period or at a timing set by a user. With the packet acquisition of this type, it is unnecessary to use a PC dedicated for packet acquisition in order to identify the cause of an image forming apparatus-related network failure (copying machine-related network failure) such as a printing speed reduction. Thus, the effort for investigation of the cause of network failure can be reduced.

With the conventional packet acquisition method described above, however, the image forming apparatus is only capable of acquiring, from the network, packets transmitted from and received by the own apparatus. In order to know a network status in, e.g., an enterprise environment where a plurality of network-connected image forming apparatuses cooperate to provide services, it is necessary for all the image forming apparatuses to acquire packets.

To this end, in the conventional packet acquisition method, image forming apparatuses are each operated for packet acquisition, and data acquired by and stored in the image forming apparatuses are fetched from the respective apparatuses.

### SUMMARY OF THE INVENTION

The present invention provides an image forming apparatus that enables, when operated, a plurality of image forming apparatuses to acquire packet data, and provides a control method and a storage medium for the image forming apparatus.

According to a first aspect of this invention, there is provided an image forming apparatus able to communicate via a network with a packet request destination image forming apparatus, which comprises an acquisition unit configured to acquire packet data transmitted and received via the network, an instruction unit configured to give the acquisition unit an instruction to perform packet data acquisition, a request unit configured to transmit a packet data acquisition request to the packet request destination image forming apparatus, and a storage unit configured to store packet data acquired by the acquisition unit according to the instruction given by the instruction unit and packet data acquired by and transmitted from the packet request destination image forming apparatus according to the request transmitted from the request unit so that these packet data are associated with each other.

According to a second aspect of this invention, there is provided an image forming apparatus able to communicate via a network with a packet request source image forming apparatus, which comprises an acquisition unit configured to acquire packet data transmitted and received via the network according to a packet data acquisition request transmitted from the packet request source image forming apparatus, and a transmission unit configured to transmit the packet data acquired by the acquisition unit to the packet request source image forming apparatus.

According to a third aspect of this invention, there is provided a control method for the image forming apparatus described in the first aspect.

According to a fourth aspect of this invention, there is provided a control method for the image forming apparatus described in the second aspect.

According to a fifth aspect of this invention, there is provided a storage medium storing a program for executing the control method described in the third aspect.

According to a sixth aspect of this invention, there is provided a storage medium storing a program for executing the control method described in the fourth aspect.

With this invention, an image forming apparatus requests each of one or more other image forming apparatuses to perform packet data acquisition at a timing where the image forming apparatus acquires packet data, thereby enabling a plurality of image forming apparatuses to acquire packet data according to an operation of the image forming apparatus. Further, the image forming apparatus is able to acquire packet data acquired by the plurality of image forming apparatuses.

Further features of the present invention will become apparent from the following description of an exemplary embodiment with reference to the attached drawings.

### BRIEF DESCRIPTION OF THE DRAWINGS

FIG. 1 is a schematic view showing the construction of a network system that includes first and second image forming apparatuses according to one embodiment of this invention;

FIG. 2 is a block diagram showing the hardware structure of the first image forming apparatus;

FIG. 3 is a block diagram showing the software structure of the first image forming apparatus;

FIG. 4 is a view showing an example of a transmission destination setting screen on which transmission destination information for image data transmission by the first image forming apparatus is set;

FIG. 5 is a diagram showing a process sequence performed between the first and second image forming apparatuses when image data is transmitted from the first image forming apparatus to the second image forming apparatus;

FIGS. 6A and 6B are views showing an example packet acquisition start API and example packet acquisition completion API, respectively, which are provided for an application program by a packet acquisition control unit of the first image forming apparatus;

FIG. 7 is a view showing an example of an extended API provided for the application program by the packet acquisition control unit of the first image forming apparatus;

FIG. 8 is a flowchart showing a process performed by the packet acquisition control unit of the first image forming apparatus when the packet acquisition start API is called;

FIG. 9 is a flowchart showing a process performed by the packet acquisition control unit of the first image forming apparatus when the packet acquisition completion API is called;

FIG. 10 is a flowchart showing a process performed by the packet acquisition control unit of the first image forming apparatus when the extended API is called; and

FIG. 11 is a flowchart showing a process performed by a packet acquisition control unit of the second image forming apparatus.

### DETAILED DESCRIPTION OF THE PREFERRED EMBODIMENT

The present invention will now be described in detail below with reference to the drawings showing a preferred embodiment thereof.

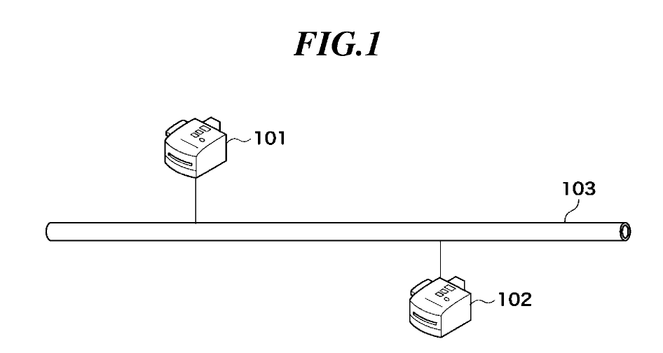

FIG. 1 schematically shows the construction of a network system (packet capture system) that includes a plurality of image forming apparatuses according to one embodiment of this invention.

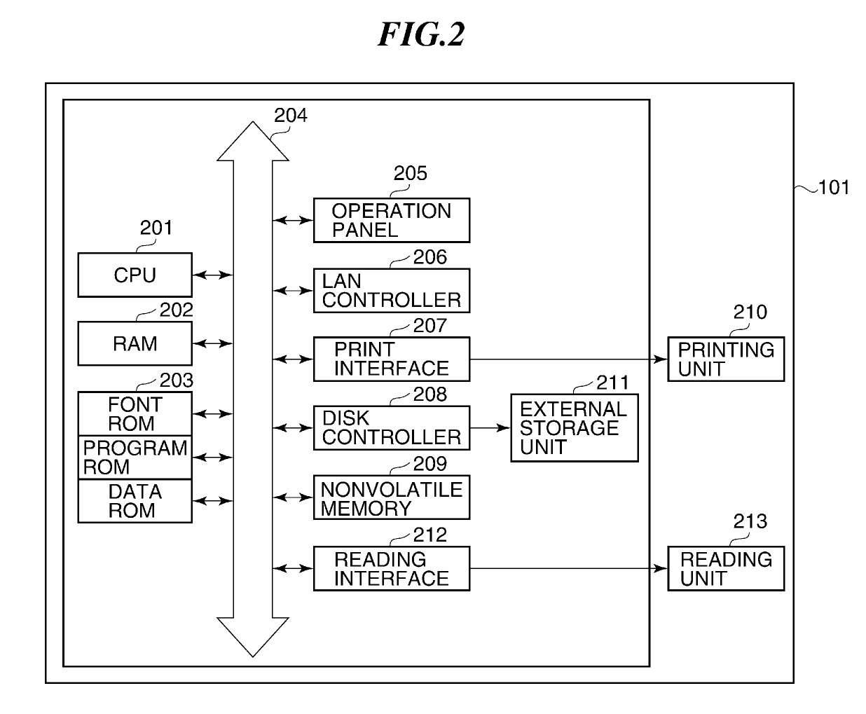

As shown in FIG. 1, the network system includes, e.g., two (first and second) image forming apparatuses 101, 102 connected for communication with each other via a network 103. The first image forming apparatus 101 (packet request source image forming apparatus) has a function of transmitting, to the second image forming apparatus 102 via the network 103, a packet data acquisition request and image data obtained by scanning an original by a reading unit (see FIG. 2).

The second image forming apparatus 102 (packet request destination image forming apparatus) has a function of acquiring packet data in response to the packet data acquisition request from the first image forming apparatus 101 and transmitting the acquired packet data to the image forming apparatus 101, and has a function of receiving image data from the first image forming apparatus 101 via the network 103 and forming (printing) an image on a recording sheet by a printing unit (see FIG. 2), as needed. The network 103 is implemented by a LAN. It should be noted that an information processing apparatus (host computer), not shown, other than the image forming apparatuses, can also be connected to the network 103.

In this embodiment, the image forming apparatuses 101, 102 are each configured as a multi-function peripheral (multi-function printer) having plural functions such as a reading function and a printing function, and are the same in hardware and software construction from each other. In the following, only the construction of the image forming apparatus 101 will be described, with a description of the construction of the image forming apparatus 102 omitted.

FIG. 2 shows in block diagram the hardware construction of the image forming apparatus 101.

As shown in FIG. 2, the image forming apparatus 101 includes a CPU 201, RAM 202, ROM 203, system bus 204, operation panel 205, LAN controller 206, print interface 207, disk controller 208, nonvolatile memory 209, printing unit 210, external storage unit 211, reading interface 212, and reading unit 213.

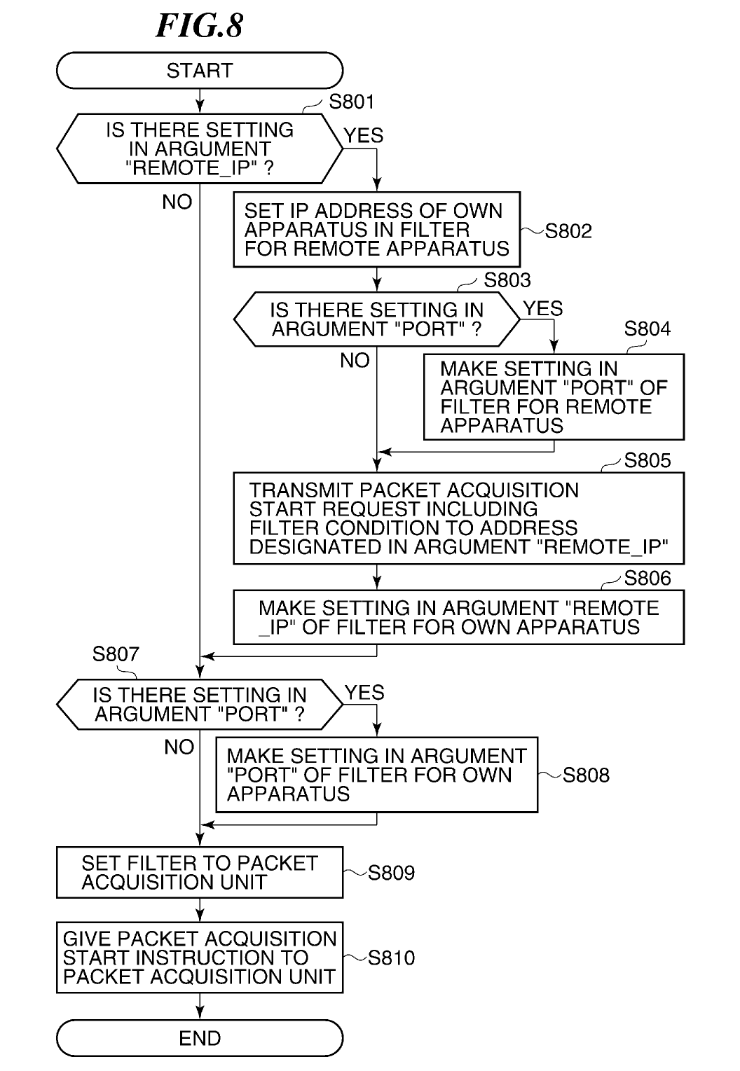

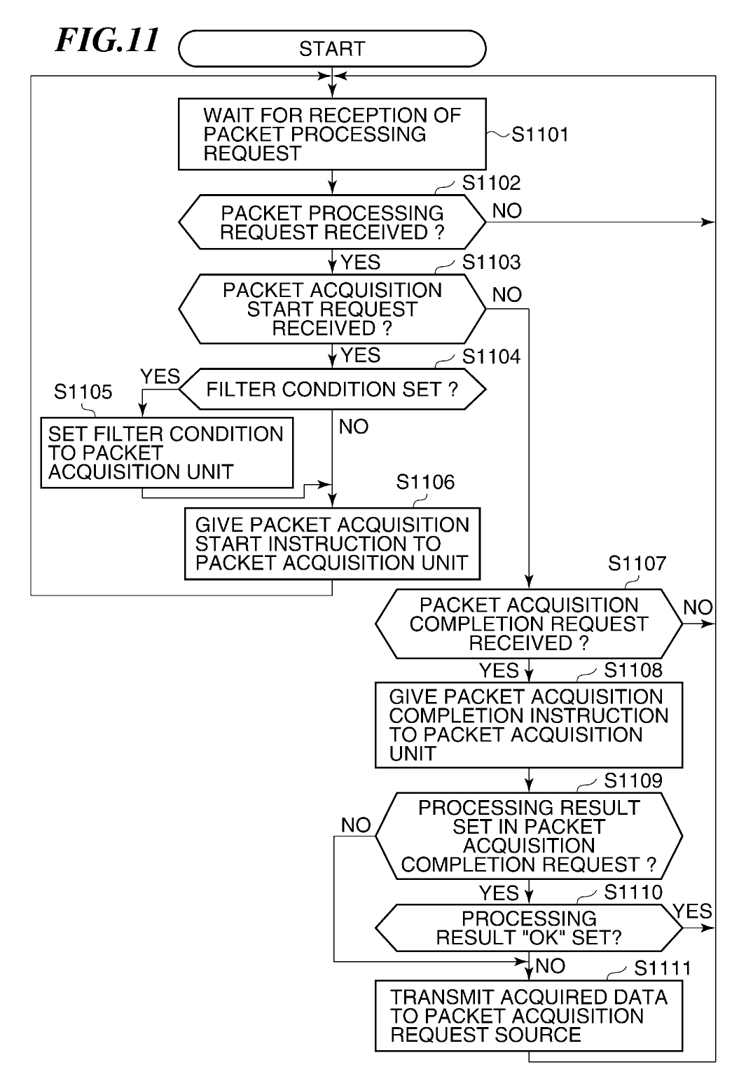

Based on a control program stored in a program ROM of the ROM 203 or stored in the external storage unit 211, the CPU 201 performs overall control of various parts of the image forming apparatus 101, which are connected to the system bus 204, and performs processes shown in flowcharts of FIGS. 8 to 11 described below. It should be noted that a process shown in FIG. 11 is performed by the CPU 201 of the image forming apparatus 102.

The CPU 201 controls image data output from the printing unit 210 connected via the print interface 207 and image data input from the reading unit 213 connected via the reading interface 212, and performs a process for communication (via the LAN controller 206) with another image forming apparatus (image forming apparatus 102 in this embodiment) and an information processing apparatus (host computer), which are connected to the network 103.

The RAM 202 mainly functions as a main memory and a work area for the CPU 201 and is also used as an output information developing region, an environment data storage region, etc. The memory capacity can be expanded by using an option RAM connected to an expansion port (not shown) of the image forming apparatus.

The ROM 203 is comprised of a font ROM, a program ROM, and a data ROM. The program ROM stores control programs, etc., the font ROM stores font data (including outline font data) used for generating image data (output information), etc., and the data ROM stores information utilized by the information processing apparatus (host computer), etc. The operation panel 205 includes a display unit and software keys, which are used by a user to input various information.

The LAN controller 206 controls communication of the image forming apparatus 101 with another image forming apparatus 102 and the information processing apparatus via the network (LAN) 103. The print interface 207 provides an interface with the printing unit (printer engine) 210 at the time of printing. The disk controller 208 controls access to (writing/reading of various data or jobs into/from) the external storage unit 211. The nonvolatile memory 209 stores various setting information, which are set via the operation panel 205. The reading interface 212 provides an interface for input of image data from the reading unit (scanner) 213.

The external storage unit 211 is implemented by, e.g., a hard disk (HDD), and used as a storage region for storing font data, emulation program, form data, etc., and a job storage region used for temporarily spooling a print job and for externally controlling the print job. It should be noted that the external storage unit 211 can be implemented by, e.g., an IC card.

The external storage unit 211 stores, as BOX data, image data read from an original by the reading unit 213 and image data for a print job to be printed by the printing unit 210. The external storage unit 211 is thus used as a BOX data storage region for storing BOX data that can be referred to or printed from the network 103. It should be noted that a plurality of external storage units 211 can be connected to the image forming apparatus, and each unit 211 can be configured to store built-in font, option font, and a program for interpreting printer control language of different language system.

It should be noted that the image forming apparatuses 101, 102 can each be mounted with an extension apparatus such as a post-processing apparatus (finisher) having stapling and sorting functions and an apparatus having a double-sided printing function. Operations of these extension apparatuses are controlled by the CPU 201.

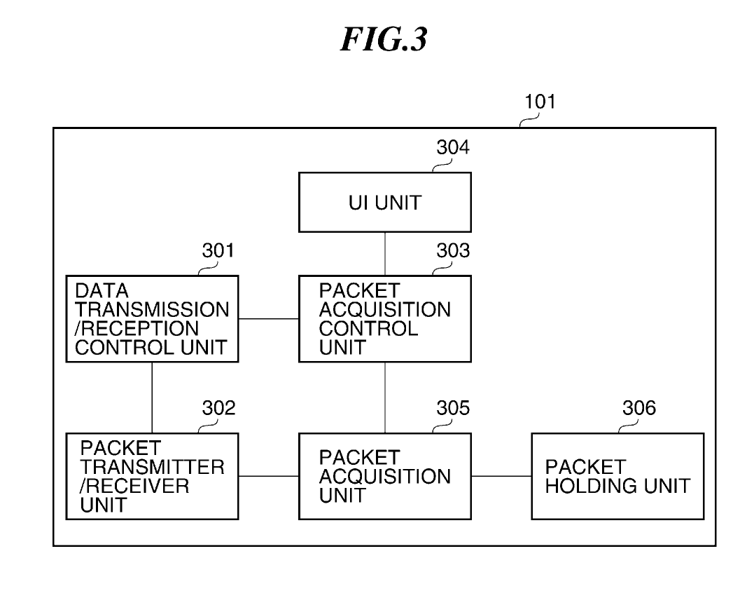

FIG. 3 shows in block diagram the software structure of the image forming apparatus 101.

As shown in FIG. 3, the image forming apparatus 101 includes a data transmission/reception control unit 301, packet transmitter/receiver unit 302, packet acquisition control unit 303, user interface (UI) unit 304, packet acquisition unit 305, and packet holding unit 306.

The data transmission/reception control unit 301 controls a communication process in which image data input from the reading unit 213 is transmitted to the network 103 via the packet transmitter/receiver unit 302 and image data is received from the network 103. The packet acquisition control unit 303 controls the packet acquisition unit 305 according to an instruction given from the data transmission/reception control unit 301 or from the UI unit 304, and exchanges, via the packet transmitter/receiver unit 302, data with devices connected to the network 103, such as another image forming apparatus and the information processing apparatus.

The packet acquisition unit 305 acquires packet data, which is transmitted from and received by the packet transmitter/receiver unit 302 via the network 103, and stores the acquired packet data as a packet file in the packet holding unit 306. The packet acquisition unit 305 is able to apply filtering at the time of packet data acquisition to thereby extract and acquire only particular packet data coincident with a packet data acquisition condition (filter condition). The packet holding unit 306 holds, as a packet file, packet data acquired by the packet acquisition unit 305.

All the software blocks shown in FIG. 3 are stored in the external storage unit 211 or the ROM 203 and loaded as an executable program into the RAM 202 when the image forming apparatus is activated. Subsequently, the software blocks are concurrently executed by the CPU 201.

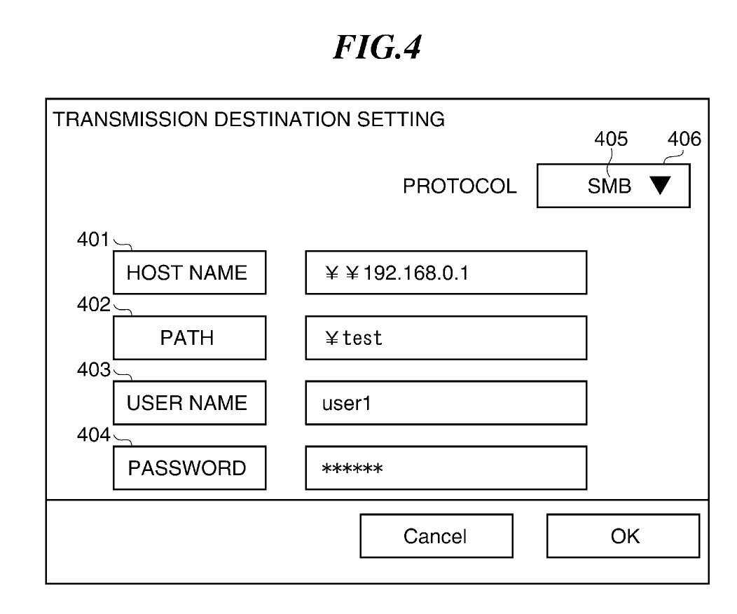

FIG. 4 shows an example of a transmission destination setting screen on which transmission destination information for image data transmission by the image forming apparatus 101 is set.

The transmission destination setting screen shown in FIG. 4 is displayed on a display unit of the operation panel 205 of the image forming apparatus 101. On the transmission destination setting screen, a host name 401, path 402, user name 403, password 404, protocol 405 can be set, which are information necessary for image data transmission from the image forming apparatus 101 to the image forming apparatus 102 (another image forming apparatus).

The host name may not be in the form of IP address. If not in the form of IP address, an input host name is converted into an IP address using DNS (domain name system) or other means. When a button 406 on the transmission destination setting screen is depressed by a user, a list of selectable protocols such as SMB (server message block), FTP (file transfer protocol), and WebDAV (web distributed authoring and versioning) is displayed on the screen.

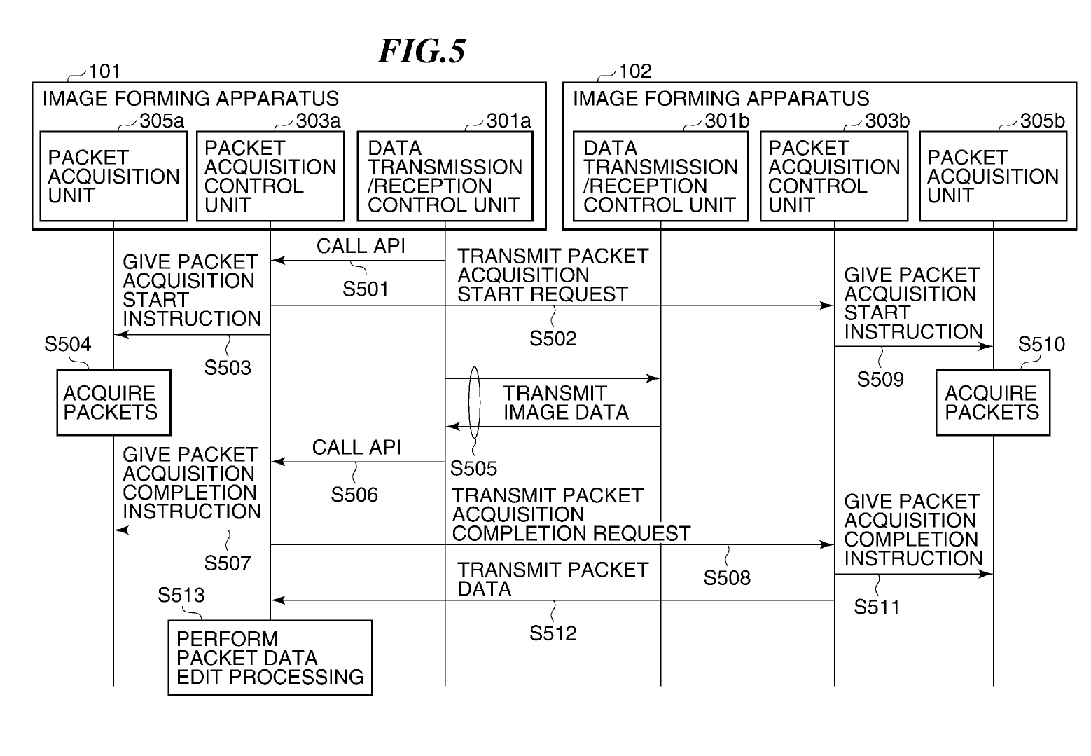

Next, with reference to FIGS. 5-11, operations of the image forming apparatuses 101, 102 will be described.

FIG. 5 shows a process sequence performed between the image forming apparatuses 101, 102 when image data is transmitted from the image forming apparatus 101 to the image forming apparatus 102.

It should be noted that for the sake of convenience, the data transmission/reception control unit 301, packet acquisition control unit 303, and packet acquisition unit 305 of the image forming apparatus 101 are each shown with a suffix a in FIG. 5 and the units 301, 303, and 305 of the image forming apparatus 102 are each shown with a suffix b in FIG. 5. Since the packet transmitter/receiver unit 302, user interface (UI) unit 304, and packet holding unit 306 of each of the image forming apparatuses 101, 102 do not directly relate to the process sequence, an illustration thereof is omitted in FIG. 5.

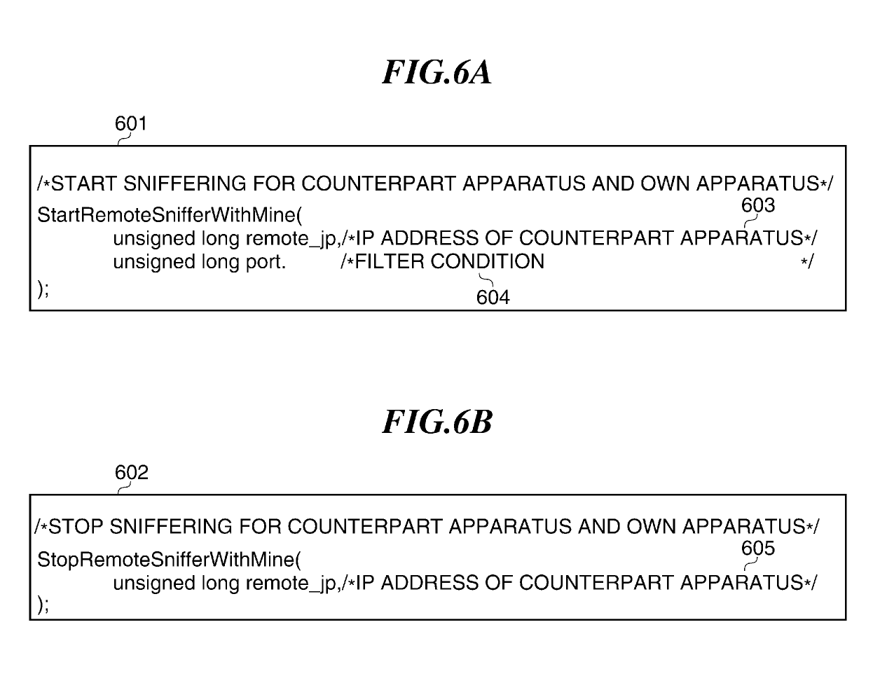

As shown in FIG. 5, the data transmission/reception control unit 301a of the image forming apparatus 101 calls a packet acquisition start API (application programming interface) provided by the packet acquisition control unit 303a (step S501). A filter condition for acquiring only desired packets can be included in or added to the packet acquisition start API so as to acquire only packet data coincident with the filter condition. The details of the packet acquisition start API will be described later with reference to FIG. 6A.

When the packet acquisition start API is called, the packet acquisition control unit 303a of the image forming apparatus 101 transmits a packet data acquisition start request to the packet acquisition control unit 303b of the image forming apparatus 102 (step S502). If the filter condition is included in the packet acquisition start API called in step S501, the packet data acquisition start request to be transmitted in step S502 is made to include the filter condition.

Simultaneously with the transmission of the packet data acquisition start request in step S502, the packet acquisition control unit 303a gives the packet acquisition unit 305a a packet data acquisition start instruction (step S503). If the filter condition is included in the packet acquisition start API called in step S501, the packet data acquisition start instruction to be transmitted in step S503 is made to include the filter condition.

When receiving the packet acquisition start instruction, the packet acquisition unit 305a starts acquiring packet data flowing through the network 103 (step S504). If the filter condition is included in the packet data acquisition start instruction received in step S503, the packet acquisition unit 305a acquires only packet data coincident with the filter condition.

Subsequently, the data transmission/reception control unit 301a of the image forming apparatus 101 transmits image data to the data transmission/reception control unit 301b of the image forming apparatus 102, which is an image data transmission destination (step S505). It should be noted that since a sequence for the image data transmission varies depending on a network protocol used for the transmission, the transmission sequence is not shown in detail in FIG. 5.

Upon completion of the image data transmission to the image forming apparatus 102, the data transmission/reception control unit 301a calls a packet acquisition completion API provided by the packet acquisition control unit 303a (step S506). Information indicating a result of processing by an application program (hereinafter, sometimes abbreviated as the application) can be included in or added to the packet acquisition completion API. The details of the API will be described later with reference to FIG. 6B.

When the packet acquisition completion API is called, the packet acquisition control unit 303a gives the packet acquisition unit 305a a packet data acquisition completion instruction (step S507). If the packet acquisition completion API called in step S506 contains information that represents a result of processing performed by the application, information representing the processing result is made to be contained in the packet data acquisition completion instruction to be given in step S507.

Simultaneously with giving the packet data acquisition completion instruction in step S507, the packet acquisition control unit 303a transmits a packet data acquisition completion request to the packet acquisition control unit 303b of the image forming apparatus 102 (step S508). If the packet acquisition completion API called in step S506 contains information representing a result of processing performed by the application, information representing the processing result is made to be contained in the packet data acquisition completion request to be transmitted in step S508.

When receiving the packet data acquisition start request from the image forming apparatus 101 in step S502, the packet acquisition control unit 303b of the image forming apparatus 102 gives the packet acquisition unit 305b a packet data acquisition start instruction (step S509). If the packet data acquisition start request received in step S502 is added with the filter condition, the packet data acquisition start instruction is made to include the filter condition.

When receiving the packet data acquisition start instruction, the packet acquisition unit 305b starts acquiring packet data flowing through the network 103 (step S510). If the filter condition is included in the packet data acquisition start instruction, the packet acquisition unit 305b only acquires packet data coincident with the filter condition.

When receiving the packet data acquisition completion request from the image forming apparatus 101 in step S508, the packet acquisition control unit 303b of the image forming apparatus 102 gives the packet acquisition unit 305b a packet data acquisition completion instruction (step S511). After confirming that the packet data acquisition by the packet acquisition unit 305b is complete, the packet acquisition control unit 303b transmits the acquired packet data to the packet acquisition control unit 303a of the image forming apparatus 101, which is a packet acquisition request source (step S512).

The packet acquisition control unit 303a performs arbitrary processing on the packet data acquired from the packet acquisition unit 305a and on the packet data received in step S512 from the image forming apparatus 102 (step S513). The arbitrary processing (predetermined processing) in this embodiment is packet data edit processing (e.g., processing for storing packet data acquired by the own apparatus and packet data acquired from another image forming apparatus into the same folder such that these packet data are associated with each other).

FIGS. 6A and 6B show an example of a packet acquisition start API 601 and an example of a packet acquisition completion API 602, respectively, which are provided for the application by the packet acquisition control unit 303a of the image forming apparatus 101.

The packet acquisition start API 601 shown in FIG. 6A, when called by the application, enables the packet acquisition unit 305a of the image forming apparatus 101 to start packet data acquisition at an arbitrary timing. An argument “remote_ip” denoted by reference numeral 603 in the API 601 represents an IP address of a remote apparatus, which should start packet data acquisition at the same timing as a start timing of packet data acquisition by the own apparatus (image forming apparatus 101). In this embodiment, the IP address of the image forming apparatus 102 (counterpart apparatus to which the image forming apparatus 101 transmits image data) is designated as the IP address of the remote apparatus.

An argument “port” denoted by reference numeral 604 in the API 601 represents a filter condition under which filtering is applied at the time of packet data acquisition. If a filter condition (e.g., a port number) is designated in the argument “port”, port number information is included in the packet data acquisition instruction given in step S503 in FIG. 5. The packet acquisition unit 305a of the image forming apparatus 101 only acquires packet data transmitted to and received from the relevant port number.

The packet acquisition completion API 602 shown in FIG. 6B, when called by the application, enables the packet data acquisition to complete at an arbitrary timing. An argument “remote_ip” denoted by reference numeral 605 in the API 602 represents an IP address of a remote apparatus, which should complete packet data acquisition at the same timing as a completion timing of packet data acquisition by the own apparatus. In this embodiment, the IP address of the image forming apparatus 102 (counterpart apparatus to which the image forming apparatus 101 transmits image data) is designated as the IP address of the remote apparatus.

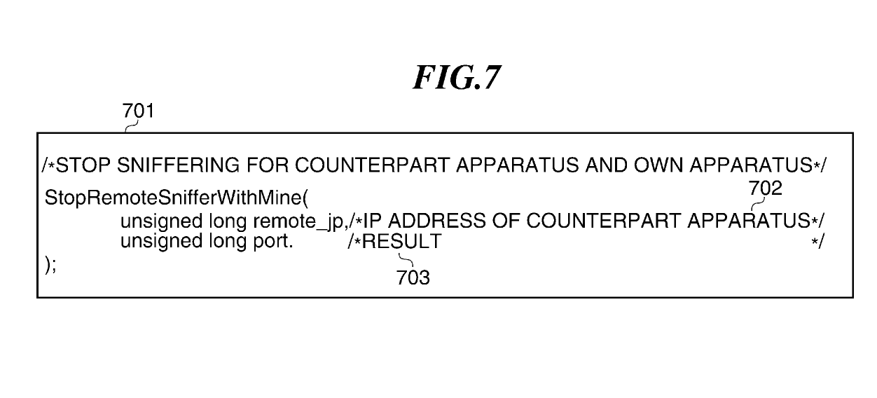

FIG. 7 shows an example of an extended API 701 provided for the application by the packet acquisition control unit 303a of the image forming apparatus 101.

The extended API 701 shown in FIG. 7 is used from an operational viewpoint that packet data is required to locate the cause of a failure that has occurred in the image forming apparatus. As an example failure, there can be mentioned a failure in image data transmission from the image forming apparatus 101 to the image forming apparatus 102.

The extended API 701 includes an argument “remote_ip” denoted by reference numeral 702 and an argument “result” denoted by reference numeral 703. When the extended API 701 is called instead of the packet acquisition request API 602, the application sets a result of processing performed by the application in the argument “result”. Specifically, a setting is made such that the result of processing performed by the application is reflected on processing to be performed on the acquired packet data, such as storing packet data.

The packet acquisition unit 305a of the image forming apparatus 101 controls based on the processing result notified from the application whether packet data (packet file) should be stored in the packet holding unit 306. On the other hand, the packet acquisition control unit 303b of the image forming apparatus 102 controls based on the processing result notified from the application whether packet data should be transmitted to the image forming apparatus 101 in step S512 in FIG. 5. The processing result notified from the application has a value of “OK” when a failure has not occurred in the image forming apparatus and has a value other than “OK” when a failure has occurred in the apparatus.

FIG. 8 shows in flowchart a process performed by the packet acquisition control unit 303a of the image forming apparatus 101 when the packet acquisition start API 601 is called.

As shown in FIG. 8, when the packet acquisition start API 601 is called, the packet acquisition control unit 303a determines whether an IP address of a remote apparatus is set in the argument “remote_ip” 603 of the API 601 (step S801).

When determining in step S801 that an IP address of a remote apparatus is set in the API 601, the packet acquisition control unit 303a sets a filter for the remote apparatus (condition for acquisition of desired packet data). To this end, the control unit 303a sets the IP address of the own apparatus (image forming apparatus 101) in the filter for the remote apparatus (step S802), and determines whether a filter condition (e.g., port number) is set in the argument “port” 604 of the API 601 (step S803). If no port number is set in the API 601, the flow proceeds to step S805.

If it is determined in step S803 that a port number is set in the argument “port” 604 of the API 601, the packet acquisition control unit 303a sets the port number, which is set in the API 601, in the filter for the remote apparatus (step S804), and transmits to the IP address designated in the argument “remote_ip” 603 in the API 601a packet data acquisition start request that includes the filter for the remote apparatus (step S805). Further, the IP address of the remote apparatus is set in a filter for the own apparatus (step S806).

If it is determined in step S801 that an IP address of a remote apparatus is not set in the API 601 or if the IP address of the remote apparatus has been set in the filter for the own apparatus in step S806, the packet acquisition control unit 303a determines whether a setting is made in the argument “port” 604 of the API 601 (step S807).

If there is no setting in the argument “port” 604 of the API 601, the flow proceeds to step S809. If there is a setting in the argument “port” 604 of the API 601, the packet acquisition control unit 303a makes a setting in the argument “port” 604 of the filter for the own apparatus (step S808), sets the created filter to the packet acquisition unit 305a of the own apparatus (image forming apparatus 101) (step S809), and gives the packet acquisition unit 305a a packet data acquisition start instruction (step S810). Then, the present process is completed.

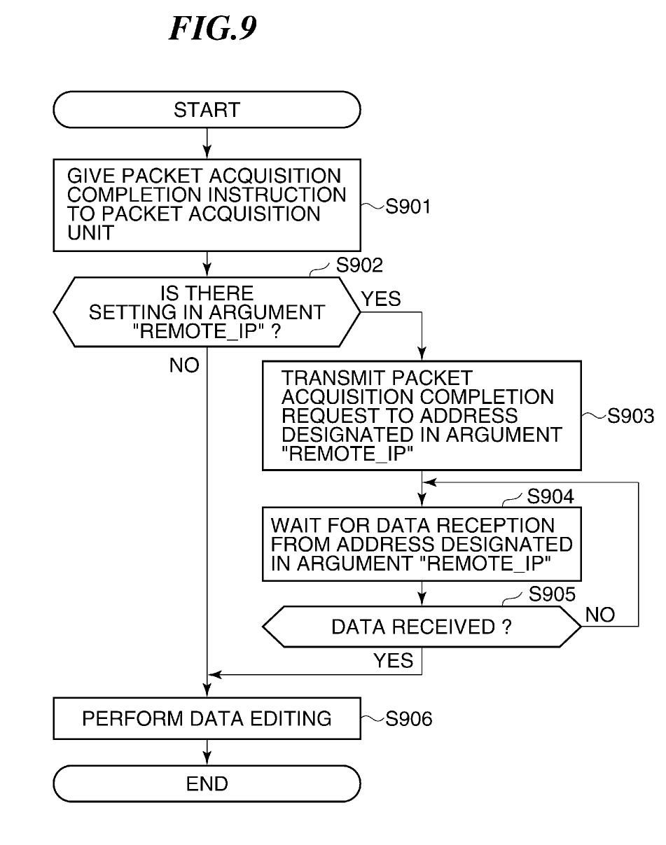

FIG. 9 shows in flowchart a process performed by the packet acquisition control unit 303a of the image forming apparatus 101 when the packet acquisition completion API 602 is called.

As shown in FIG. 9, the packet acquisition control unit 303a gives the packet acquisition unit 305a of the own apparatus (image forming apparatus 101) a packet data acquisition completion instruction when the API 602 is called (step S901), and determines whether an IP address of a remote apparatus is set in the argument “remote_ip” 605 of the API 602 (step S902).

If an IP address of a remote apparatus is set in the argument “remote_ip” 605 of the API 602, the packet acquisition control unit 303a transmits a packet acquisition completion request to the IP address designated in the argument “remote_ip” 605 (step S903), waits for reception of packet data from the IP address designated in the argument “remote_ip” 605 (step S904), and determines whether packet data is received (step S905). If no packet data is received, the flow returns to step S904.

When receiving packet data, the packet acquisition control unit 303a performs data editing (step S906). In this embodiment, the control unit 303a stores the packet data acquired by the own apparatus (image forming apparatus 101) and the packet data received from the image forming apparatus 102 in step S905 into the same folder such that these packet data are associated with each other.

If it is determined in step S902 that an IP address of a remote apparatus is not set in the argument “remote_ip” 605 of the packet acquisition completion API 602, the packet acquisition control unit 303a performs editing only on the packet data acquired by the own apparatus (image forming apparatus 101) (step S906). In this embodiment, the control unit 303a stores the packet data acquired by the own apparatus into the folder. Then, the present process is completed.

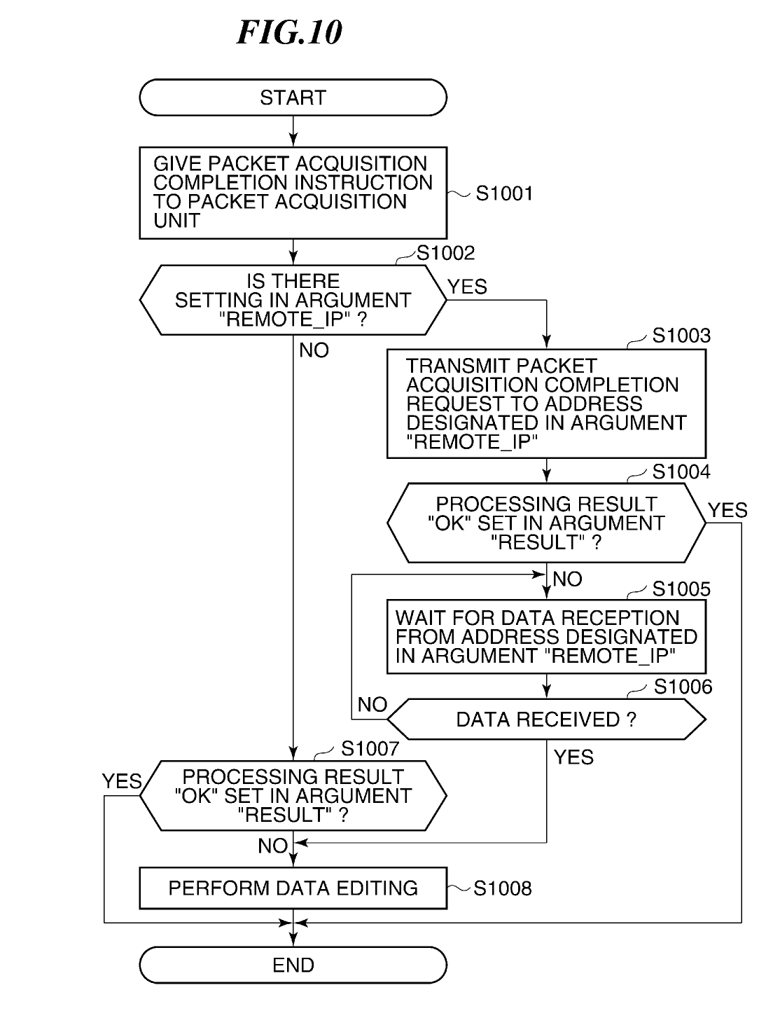

FIG. 10 shows in flowchart a process performed by the packet acquisition control unit 303a of the image forming apparatus 101 when the extended API 701 is called.

As shown in FIG. 10, the packet acquisition control unit 303a gives the packet acquisition unit 305a of the own apparatus (image forming apparatus 101) a packet data acquisition completion instruction when the extended API 701 is called (step S1001), and determines whether an IP address of a remote apparatus is set in the argument “remote_ip” 702 of the extended API 701 (step S1002).

If an IP address of a remote apparatus is set in the argument “remote_ip” 702 of the extended API 701, the packet acquisition control unit 303a transmits a packet data acquisition completion request to the IP address designated in the argument “remote_ip” 702 (step S1003), and determines whether a result “OK” of the processing performed by the application is set in the argument “result” 703 of the extended API 701 (step S1004). If the processing result “OK” is set in the argument “result”, the packet acquisition control unit 303a determines that a failure has not occurred in the image forming apparatus and packet data editing (described later) is unnecessary, whereupon the present process is completed.

If a value other than the processing result “OK” is set in the argument “result” 703 of the extended API 701, the packet acquisition control unit 303a waits for reception of packet data from the IP address designated in the argument “remote_ip” 702 (step S1005), and determines whether packet data is received (step S1006). If packet data is not received, the flow returns to step S1005.

When receiving packet data, the packet acquisition control unit 303a performs data editing (step S1008). In this embodiment, the control unit 303a stores packet data acquired by the own apparatus (image forming apparatus 101) and packet data acquired from the image forming apparatus 102 in step S1006 into the same folder such that these packet data are associated with each other. Then, the present process is completed.

If it is determined in step S1002 that the IP address of the remote apparatus is not set in the argument “result” 703 of the extended API 701, the packet acquisition control unit 303a determines whether the result “OK” of processing performed by the application is set in the argument “result” 703 of the extended API 701 (step S1007). If the processing result “OK” is set, the packet acquisition control unit 303a determines that a failure has not occurred in the image forming apparatus and the packet data editing is unnecessary, whereupon the present process is completed.

If a value other than the processing result “OK” is set in the argument “result” 703 of the extended API 701, the packet acquisition control unit 303a performs data editing only on the packet data acquired by the own apparatus (image forming apparatus 101) (step S1008). In this embodiment, the control unit 303a stores the packet data acquired by the own apparatus into the folder. Then, the present process is completed.

FIG. 11 shows in flowchart a process performed by the packet acquisition control unit 303b of the image forming apparatus 102.

As shown in FIG. 11, the packet acquisition control unit 303b waits for reception of a packet data processing request (packet acquisition start or completion request) from the network 103 (step S1101), and determines whether the packet data processing request is received (step S1102). If the packet data processing request is not received, the flow returns to step S1101.

When receiving the packet data processing request, the packet acquisition control unit 303b determines whether the received request is a packet data acquisition start request (step S1103). If the packet data acquisition start request is received, the control unit 303b determines whether a filter condition is set in the acquisition start request (step S1104).

If a filter condition is set in the packet data acquisition start request, the packet acquisition control unit 303b sets the filter condition to the packet acquisition unit 305b of the own apparatus (image forming apparatus 102) (step S1105), and gives the packet acquisition unit 305b of the own apparatus a packet data acquisition start instruction (step S1106). Then, the flow returns to step S1101. If a filter condition is not set in the packet data acquisition start request, the packet acquisition control unit 303b skips step S1105 and gives the packet data acquisition start instruction (step S1106), whereupon the flow returns to step S1101.

If it is determined in step S1103 that the received packet data processing request is not a packet data acquisition start request, the packet acquisition control unit 303b determines whether the received request is a packet data acquisition completion request (step S1107). If a packet data acquisition completion request is not received, the flow returns to step S1101.

If a packet data acquisition completion request is received, the packet acquisition control unit 303b gives the packet acquisition unit 305b of the own apparatus (image forming apparatus 102) a packet data acquisition completion instruction (step S1108), and determines whether a processing result is set in the packet data acquisition completion request (step S1109). If a processing result is not set in the acquisition completion request, the flow proceeds to step S1111. If a processing result is set in the acquisition completion request, the packet acquisition control unit 303b determines whether a processing result “OK” is set (step S1110). If a processing result “OK” is set, the packet acquisition control unit 303b determines that a failure has not occurred and it is unnecessary to perform packet data transmission (described later) to the packet acquisition request source, whereupon the flow returns to step S1101.

If it is determined in step S1110 that a value other than the processing result “OK” is set in the packet data acquisition completion request, the packet acquisition control unit 303b of the image forming apparatus 102 transmits the acquired packet data to the image forming apparatus 101, which is a packet data acquisition request source (step S1111), whereupon the flow returns to step S1101.

As described above, according to this embodiment, the following effect is attained. Specifically, an image forming apparatus requests another one or more image forming apparatuses to perform packet data acquisition at a timing where the own apparatus acquires packet data, whereby packet data acquisition at a plurality of image forming apparatuses can be achieved by the operation of one image forming apparatus. Then, the image forming apparatus receives pieces of packet data acquired by the other one or more image forming apparatuses to each of which the packet data acquisition has been given, whereby packet data at the plurality of image forming apparatuses can be acquired by the one image forming apparatus.

### Other Embodiment

In the above-described embodiment, a case has been described where two image forming apparatuses are connected to the network, but the number of network-connected image forming apparatuses is not limited to two but may be an arbitrary number without departing from the gist of the present invention.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2009-217432, filed Sep. 18, 2009, which is hereby incorporated by reference herein in its entirety.

What is claimed is:

1. An image forming apparatus able to communicate via a network with a packet request destination image forming apparatus, comprising:
an acquisition unit configured to acquire packet data transmitted and received via the network;
an instruction unit configured to give said acquisition unit an instruction to perform packet data acquisition;
a request unit configured to transmit a packet data acquisition request to the packet request destination image forming apparatus; and
a storage unit configured to store packet data acquired by said acquisition unit according to the instruction given by said instruction unit and packet data acquired by and transmitted from the packet request destination image forming apparatus according to the request transmitted from said request unit so that these packet data are associated with each other.

2. The image forming apparatus according to claim 1, further including:
a setting unit configured to set a packet data acquisition condition under which particular packet data among the packet data transmitted and received via the network is extracted and acquired,
wherein said instruction unit adds the packet data acquisition condition set by said setting unit to the instruction for packet data acquisition to be given to said acquisition unit, and
said request unit adds the packet data acquisition condition set by said setting unit to the packet data acquisition request to be transmitted to the packet request destination image forming apparatus.

3. The image forming apparatus according to claim 1, further including:
a judgment unit configured to determine whether the packet data acquired by said acquisition unit is to be stored or not based on a result of processing performed by an application program on the packet data transmitted and received via the network.

4. An image forming apparatus able to communicate via a network with a packet request source image forming apparatus, comprising:
an acquisition unit configured to acquire packet data transmitted and received via the network according to a packet data acquisition request transmitted from the packet request source image forming apparatus; and
a transmission unit configured to transmit the packet data acquired by said acquisition unit to the packet request source image forming apparatus.

5. The image forming apparatus according to claim 4, wherein said acquisition unit acquires, based on a packet data acquisition condition that is added to the packet data acquisition request transmitted from the packet request source image forming apparatus, packet data that satisfies the packet data acquisition condition among the packet data transmitted and received via the network.

6. The image forming apparatus according to claim 4, wherein in a case where a setting that reflects a result of processing performed by an application program is added to a packet acquisition completion request transmitted from the packet request source image forming apparatus, said transmission unit determines, based on the result of processing performed by the application program, whether the packet data acquired by said acquisition unit should be transmitted to the packet request source image forming apparatus.

7. A control method for an image forming apparatus able to communicate via a network with a packet request destination image forming apparatus, comprising:
an acquisition step of acquiring packet data transmitted and received via the network;
an instruction step of giving said acquisition step an instruction to perform packet data acquisition;
a request step of transmitting a packet data acquisition request to the packet request destination image forming apparatus; and
a storage step of storing packet data acquired in said acquisition step according to the instruction given in said instruction step and packet data acquired by and transmitted from the packet request destination image forming apparatus according to the request transmitted in said request step so that these packet data are associated with each other.

8. A control method for an image forming apparatus able to communicate with a network with a packet request source image forming apparatus, comprising:
an acquisition step of acquiring packet data transmitted and received via the network according to a packet data acquisition request transmitted from the packet request source image forming apparatus; and
a transmission step of transmitting the packet data acquired in said acquisition step to the packet request source image forming apparatus.

9. A non-transitory computer-readable storage medium storing a program for causing a computer to execute the control method as set forth in claim 7.

10. A non-transitory computer-readable storage medium storing a program for causing a computer to execute the control method as set forth in claim 8.
